(19) United States
(12) Patent Application Publication
(10) Pub. No.: US 2026/0089293 A1
(43) Pub. Date: Mar. 26, 2026

(54) SYSTEMS AND METHODS FOR USING ARTIFICIAL INTELLIGENCE WITH DIGITAL SHARED CONNECTIONS SPACES

(71) Applicant: Google LLC, Mountain View, CA (US)

(72) Inventors: Pablo Federico Majernik, Sammammish, WA (US); Ricardo Paz, San Jose, CA (US); Evan Smithers, Portland, OR (US); Juan Carlos Angustia Garcia, Philadelphia, PA (US); Kimberly Ha, Seattle, WA (US); Humberto Castaneda, Kirkland, WA (US)

(21) Appl. No.: 18/892,927

(22) Filed: Sep. 23, 2024

(51) Int. Cl. H04N 7/15; G06F 3/14

(52) U.S. Cl. CPC H04N 7/157; G06F 3/1454; H04N 7/152

(57) ABSTRACT

A method for using artificial intelligence (AI) with a digital shared connections spaces includes causing a virtual meeting user interface (UI) to be presented during a virtual meeting between one or more participants. The method includes determining, using an AI model and one or more participant actions during the virtual meeting as input to the AI model, that at least one participant is interested in using a shared connections space that is configured to present one or more images of one or more media items referenced during the virtual meeting. The method includes instructing a shared connections space platform to generate the shared connections space. The one or more images of the one or more media items referenced during the virtual meeting are viewable on a shared connections space UI after the virtual meeting is concluded.

### TECHNICAL FIELD

Aspects and implementations of the present disclosure relate to virtual meetings and more specifically to using artificial intelligence with digital shared connections spaces.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the virtual meeting platform can provide a user interface that includes multiple regions to present the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

One aspect of the disclosure includes a method. The method includes causing a virtual meeting user interface (UI) to be presented during a virtual meeting between one or more participants. The virtual meeting UI includes one or more first regions each corresponding to a participant of the one or more participants. The method includes determining, using an artificial intelligence (AI) model and one or more participant actions during the virtual meeting as input to the AI model, that at least one participant of the one or more participants is interested in using a shared connections space that is configured to present one or more images of one or more media items referenced during the virtual meeting. The method includes instructing a shared connections space platform to generate the shared connections space. The one or more images of the one or more media items referenced during the virtual meeting are viewable on a shared connections space UI after the virtual meeting is concluded.

Another aspect of the disclosure includes a system. The system includes a memory and processing device coupled to the memory. The processing device is configured to perform operations. The operations include causing a virtual meeting UI to be presented during a virtual meeting between one or more participants. The virtual meeting UI includes one or more first regions each corresponding to a participant of the one or more participants. The operations include determining, using an AI model and one or more participant actions during the virtual meeting as input to the AI model, that at least one participant of the one or more participants is interested in using a shared connections space that is configured to present one or more images of one or more media items referenced during the virtual meeting. The operations include instructing a shared connections space platform to generate the shared connections space. The one or more images of the one or more media items referenced during the virtual meeting are viewable on a shared connections space UI after the virtual meeting is concluded.

Another aspect of the disclosure includes a non-transitory computer-readable storage medium that instructions. The instructions, when executed by a processing device, cause the processing device to perform operations. The operations include causing a virtual meeting to be presented during a virtual meeting between one or more participants. The virtual meeting UI includes one or more first regions each corresponding to a participant of the one or more participants. The operations include determining, using an AI model and one or more participant actions during the virtual meeting as input to the AI model, that at least one participant of the one or more participants is interested in using a shared connections space that is configured to present one or more images of one or more media items referenced during the virtual meeting. The operations include instructing a shared connections space platform to generate the shared connections space. The one or more images of the one or more media items referenced during the virtual meeting are viewable on a shared connections space UI after the virtual meeting is concluded.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for using artificial intelligence (AI) with digital shared connections spaces, in accordance with some implementations of the present disclosure.

FIG. 2 illustrates a schematic diagram of an AI training subsystem, in accordance with some implementations of the present disclosure.

FIG. 2 illustrates a schematic diagram of an AI inference subsystem, in accordance with some implementations of the present disclosure.

FIG. 4 depicts a flow diagram of a method for using AI with digital shared connections spaces, in accordance with some implementations of the present disclosure.

FIG. 5 depicts a user interface (UI) for a virtual meeting, in accordance with some implementations of the present disclosure.

FIG. 6 depicts another UI for a virtual meeting, in accordance with some implementations of the present disclosure.

FIG. 7 depicts UI displaying a visual collaboration space of a shared connections space, in accordance with some implementations of the present disclosure.

FIG. 8 is a block diagram illustrating an example computer system, in accordance with some implementations of the present disclosure.

### DETAILED DESCRIPTION

Aspects of the present disclosure relate to systems and methods for using artificial intelligence (AI) with digital shared connections spaces. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting. A participant of a virtual meeting can speak to the other participants of the virtual meeting. Some existing virtual meeting platforms can provide a user interface (UI) to each client device connected to the virtual meeting, where the UI displays visual items corresponding to the video streams shared over the network in a set of regions in the UI.

In a typical virtual meeting, participants can share documents, files, or other data with each other during the virtual meeting. This may include a first participant sharing the participant's screen to show a slide presentation or the first participant providing a link to a document stored in cloud storage in a text chat of the virtual meeting UI. However, participants sharing data during a virtual meeting can only use a limited number of predetermined formats (screen sharing, sharing data via a text chat, etc.). Furthermore, the shared data is only available for viewing or access by participants during the virtual meeting. For example, after the virtual meeting, screen sharing is no longer available, and the text chat (including messages where a participant has shared data) do not persist.

Implementations of the present disclosure address the above and other deficiencies by connecting a participant of a virtual meeting to a shared connections space when determining, using an AI model to determine, that the participant of the virtual meeting is interested in using the shared connections space. The shared connections space refers to a collaborative visual space that includes media items, which are added by participants of the shared connections space and which can be viewed by and interacted with by other participants of the shared connections space. The media items can include images, audio, videos, software code, documents, links to web resources, or any other content items. The collaborative visual space can act like a bulletin board where participants can add media items, spatially rearrange the media items, and interact with the media items (e.g., play a video, view an image, listen to audio). The collaborative visual space persists even when no participants of the shared connections space are connected to the shared connections space.

Aspects and implementations of the present disclosure provide a shared connections space platform that allows participants to use a shared connections space as a dedicated, informal space that enables its participants to share media items, connect with each other, and collaborate. Aspects and implementations of the present disclosure also provide functionality during a virtual meeting that uses AI to automatically detect that participants of the virtual meeting are interested in using a shared connections space. The functionality can also automatically add media items shared during the virtual meeting to the shared connections space. Furthermore, because the shared connections space persists even when participants are not currently connected, participants can interact with each other on their own time, providing media items to the visual collaboration space for later use by other participants. As a result, computing resources otherwise needed to allow users to locate media items of interest are no longer consumed.

Aspects of the present disclosure provide technical advantages over previous solutions. One technical problem includes unnecessary consumption of computing resources due to the limited ways by which participants of a virtual meeting share documents and other data. Aspects of the present disclosure provide a technical solution by (1) providing an AI model that automatically detects that participants are interested in using a shared connections space, (2) automatically generating the shared connections space and automatically adding media items shared during the virtual meeting to the shared connections space, and (2) providing the participants access to the shared connections space where participants can visually share documents and other data beyond the predefined formats of a virtual meeting so the data can be accessed by multiple participants in a visual manner. Another technical problem related to virtual meetings includes the documents and other data shared during a virtual meeting not being accessible by participants of the meeting after the conclusion of the meeting. Aspects of the present disclosure provide a technical solution by providing a shared connections space where documents and other information remain in a collaborative visual space even when other participants of the shared connections space are not currently accessing the space. Thus, the aspects and implementations of the present disclosure enhance the experience of virtual meeting participants.

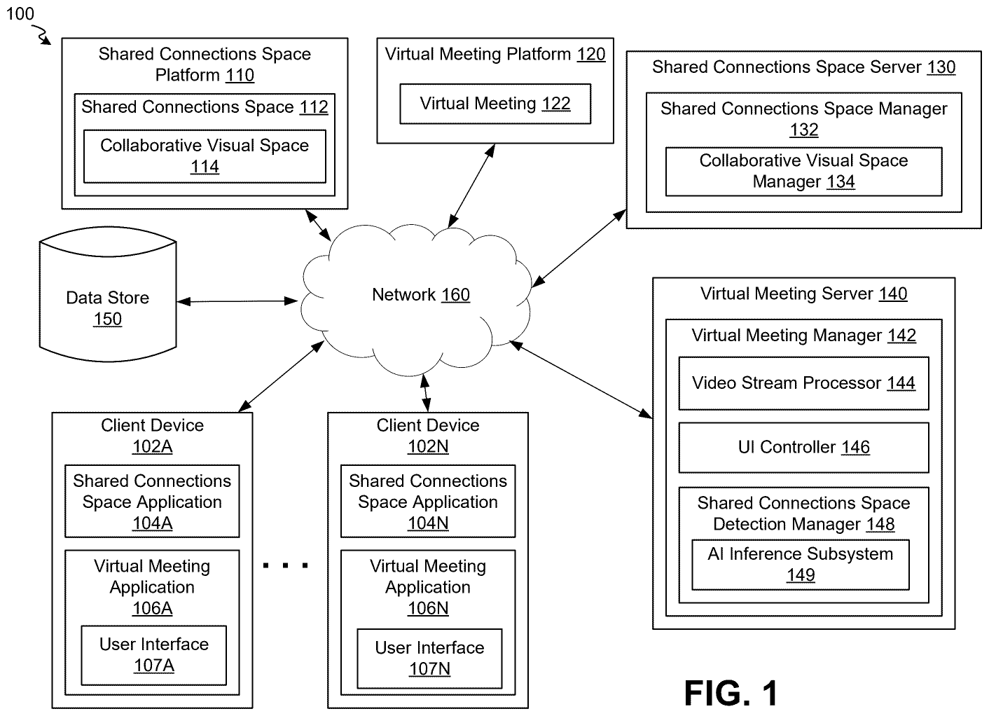

FIG. 1 illustrates an example system architecture 100, in accordance with implementations of the present disclosure. The system architecture 100 includes one or more client devices 102A-N, a shared connections space platform 110, a virtual meeting platform 120, a shared connections space server 130, a virtual meeting server 140, and a data store 150, each connected to a network 160.

In some implementations, the shared connections space platform 110 enables users of one or more of the client devices 102A-N to participate in a shared connections space (e.g., a shared connections space 112). A shared connections space 112 refers to a digital space where users of the one or more client devices 102A-N (referred to herein as “shared connections space participants”) can add one or more media items for viewing or access by shared connections space participants of the shared connections space 112. The shared connections space 112 may include a collaborative visual space 114. The collaborative visual space 114 may include a graphical UI that includes images corresponding to the media items. A shared connections space participant of the shared connections space may view the collaborative visual space 114 on a client device 102A-N, interact with the one or more media items of the collaborative visual space 114, or add a media item to the collaborative visual space 114.

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the shared connections space platform 110, the virtual meeting platform 120, the shared connections space manager 132, or the virtual meeting manager 142 collects user information (e.g., information about a user's social network, social actions or activities, profession, a user's preferences, or a user's current location), or to control whether or how to receive content from the shared connections space platform 110, the virtual meeting platform 120, the shared connections space manager 132, or the virtual meeting manager 142 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the shared connections space platform 110, the virtual meeting platform 120, the shared connections space manager 132, or the virtual meeting manager 142.

In one or more implementations, a shared connections space participant can request to create the shared connections space 112. The shared connections space platform 110 can generate the shared connections space 112 on behalf of one or more shared connections space participants. In some implementations, the shared connections space includes one or more host participants. A host participant may include a shared connections space participant that has more permissions or privileges regarding the shared connections space 112 than non-host participants. A host participant can invite users to join the shared connections space 112 as shared connections space participants. In one implementation, the shared connections space 112 may not be accessible by users that have not been invited to join the shared connections space 112. Access to the shared connections space 112 can be controlled using participants'identifying information (e.g., email addresses, names, etc.) or any other similar information. In some implementations, the shared connections space 112 may be joinable by any user. Implementations of the present disclosure can be implemented with any number of participants connecting via the shared connections space 112 (e.g., up to one hundred or more).

In some implementations, the virtual meeting platform 120 enables users of one or more of the client devices 102A-N connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 may include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120. Implementations of the present disclosure can be implemented with any number of virtual meeting participants connecting via the virtual meeting 122 (e.g., up to one hundred or more).

In one or more implementations, the shared connections space server 130 includes a shared connections space manager 132. The shared connections space manager 132, in some implementations, is configured to manage a shared connections space 112 that includes multiple users of the shared connections space platform 110. The shared connections space manager 132 can provide shared connections space UIs to each client device 102A-N to enable users to view the collaborative visual space 114 and interact with media items included in the collaborative visual space 114. The shared connections space manager 132 can also collect and provide data associated with the shared connections space 112 to each participant of the shared connections space 112. In some implementations, the shared connections space manager 132 provides the shared connections space UIs for presentation by shared connections space applications 104A-N. For example, the respective shared connections space UIs can be displayed on the display devices by the shared connections space applications 104A-N executing on the operating systems of the client devices 102A-N. In some implementations, the shared connections space manager 132 determines images corresponding to media items for presentation in the shared connections space UIs.

In one or more implementations, the shared connections space manager 132 includes a collaborative visual space manager 134. The collaborative visual space manager 134 may include a software application (or a subset thereof) configured to perform certain collaborative visual space functionality. For example, the collaborative visual space manager 134 may be configured to obtain a media item and an indication of the location in the collaborative visual space 114 where an image representing the media item is to be displayed; store the media item and location data; and, responsive to receiving a request from a shared connections space UI of an application 104A-N of a client device 102A-N, retrieve the media item and location data and provide it to the shared connections space UI for displaying the collaborative visual space 114 on the shared connections space UI.

In some implementations, the virtual meeting server 140 includes a virtual meeting manager 142. The virtual meeting manager 142, in one or more implementations, is configured to manage a virtual meeting 122 between multiple users of the virtual meeting platform 120. The virtual meeting manager 142 can provide respective virtual meeting UIs 107A-N to each client device 102A-N to enable users to watch and listen to each other during a virtual meeting 122. The virtual meeting manager 142 can also collect and provide data associated with the virtual meeting 122 to each participant of the virtual meeting 122. In some implementations, the virtual meeting manager 142 determines visual items for presentation in the virtual meeting UIs 107A-N during a virtual meeting 122. A visual item can refer to a virtual meeting UI element that occupies a particular region in the virtual meeting UI 107A-N and is dedicated to presenting a video stream from a respective client device. Such a video stream can depict, for example, a user of the respective client device 102A-N while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 142 includes a video stream processor 144 and a UI controller 146. Each of the video stream processor 144 or the UI controller 146 may include a software application (or a subset thereof) that performs certain virtual meeting functionality for the virtual meeting manager 142. The video stream processor 144 may be configured to receive video streams from one or more of the client devices 102A-N. The video stream processor 144 may be configured to determine visual items for presentation in the virtual meeting UIs 107A-N of such client devices 102A-N during the virtual meeting 122. Each visual item can correspond to a video stream from a client device 102A-N (e.g., the video stream pertaining to one or more participants of the virtual meeting 122). In some implementations, the video stream processor 144 receives audio streams associated with the video streams from the client devices (e.g., from an audiovisual component of the client devices 102A-N). Once the video stream processor 144 has determined visual items for presentation in the virtual meeting UI, the video stream processor 144 can notify the UI controller 146 of the determined visual items. The visual items for presentation can be determined based on current speaker, current presenter, order of the participants joining the virtual meeting 122, list of participants (e.g., alphabetical), etc.

In some implementations, the UI controller 146 provides the virtual meeting UI for the virtual meeting 122 (e.g., the UI 107A-N). As discussed above, the virtual meeting UI 107A-N can include multiple regions. Each region can display a visual item representing a video stream pertaining to one or more participants of the virtual meeting 122. The UI controller 146 can control which video stream is to be used by providing a command to one or more client devices 102A-N that indicates which video stream is to be represented in which region of the virtual meeting UI 107A-N (along with the received video and audio streams being provided to the client devices 102A-N). For example, in response to being notified of the determined visual items for presentation in the virtual meeting UI 107A-N, the UI controller 146 can transmit a command causing each determined visual item to be displayed in a region of the virtual meeting UI 107A-N and/or rearranged in the virtual meeting UI 107A-N.

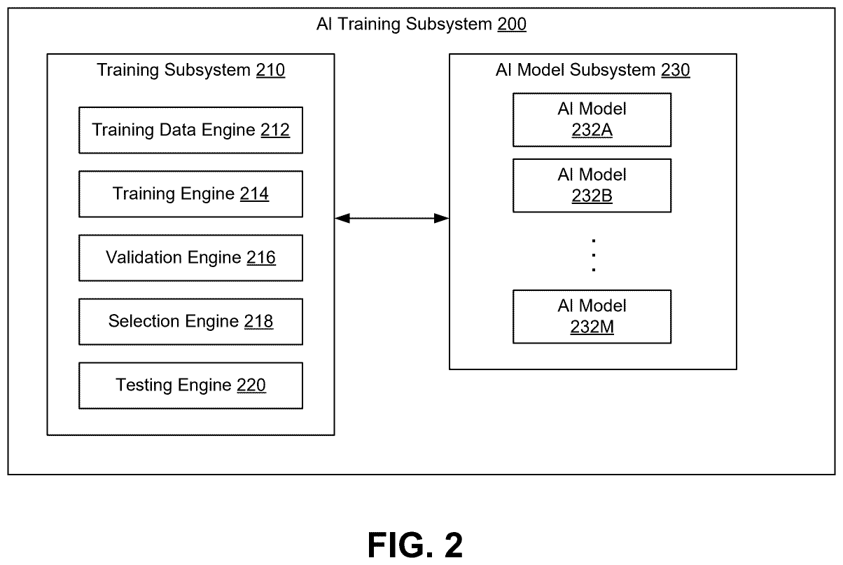

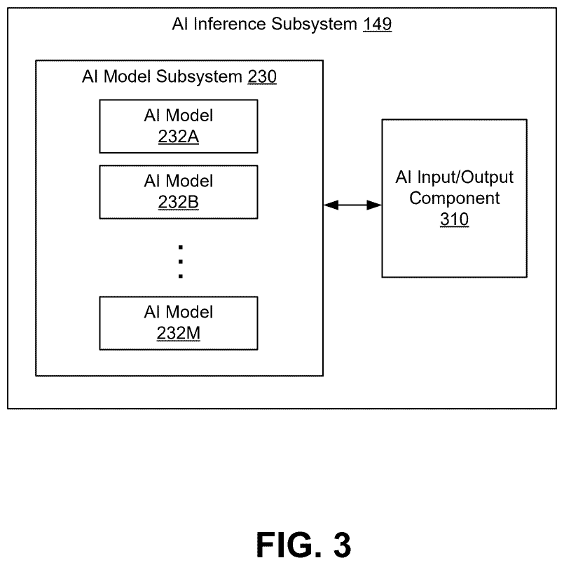

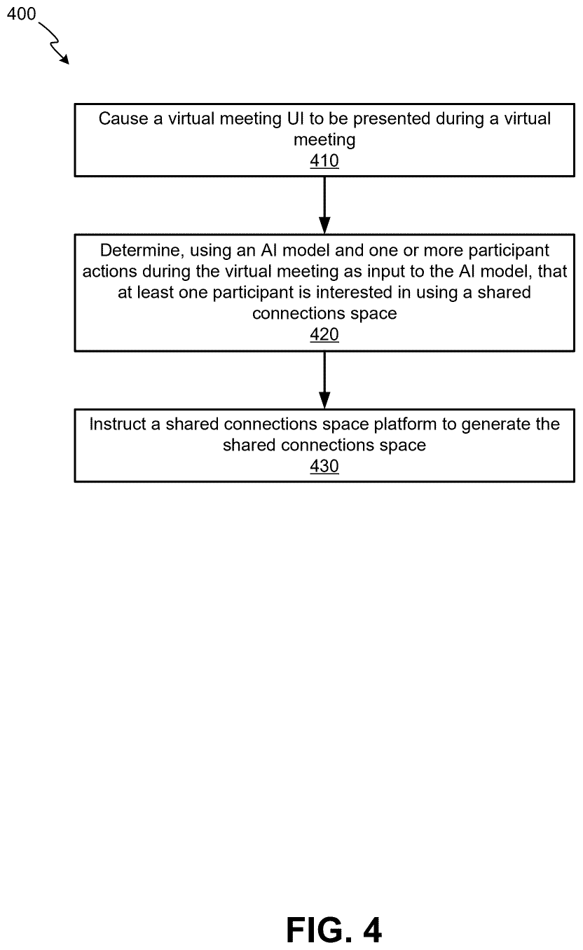

In one or more implementations, the virtual meeting manager 142 includes a shared connections space detection manager 148. The shared connections space detection manager 148 may include a software application (or a subset thereof) that performs certain virtual meeting functionality for the virtual meeting manager 142. The shared connections space detection manager 148 may be configured to determine that at least one participant of the one or more participants of the virtual meeting 122 is interested in using a shared connections space 112. The shared connections space detection manager 148 may be further configured to instruct the shared connections space platform 110 or the shared connections space manager 132 to generate the shared connections space 112. The shared connections space detection manager 148 may include an AI inference subsystem 149. The AI inference subsystem 149 may include one or more AI models that may assist the shared connections space detection manager 148 in determining that a participant of the virtual meeting 122 is interested in using a shared connections space 112. Further details regarding the AI inference subsystem 149 are discussed below in relation to FIG. 2 and FIG. 3. Further details regarding the functionality of the shared connections space detection manager 148 are discussed below in relation to FIG. 4.

In some implementations, each of the shared connections space platform 110, the virtual meeting platform 120, the shared connections space server 130, or the virtual meeting server 140 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a shared connections space 112 or a virtual meeting 122. The shared connections space platform 110 or the virtual meeting platform 120 can also each include a respective website (e.g., one or more webpages) or application back-end software that can be used to enable a user to connect with other users by way of the shared connections space 112 or the virtual meeting 122 as applicable.

In some implementations, the one or more client devices 102A-N each include one or more computing devices such as personal computers (PCs), laptops, mobile phones, smart phones, tablet computers, netbook computers, network-connected televisions, etc. The one or more client devices 102A-N can also be referred to as “user devices.” Each client device 102A-N can include an audiovisual component. The audiovisual component can generate audio data to be streamed to the shared connections space manager 132. The audiovisual component can generate audio or video data to be streamed to the virtual meeting manager 142. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component includes an image capture device (e.g., a camera) to capture images and generate video data (e.g., a video stream) of the captured data of the captured images.

In some implementations, a client device 102A-N can be associated with a physical conference or meeting room. Such client device 102A-N can include or be coupled to a media system that can include one or more display devices, one or more speakers, and one or more cameras. The display device can be, for example, a smart display or a non-smart display (e.g., a display that is not itself configured to connect to the network 160). Users that are physically present in the room can use the media system rather than their own devices (e.g., one or more of the client other devices 102A-N) to participate in the shared connections space 112 or the virtual meeting 122, which can include other remote users. For example, the users in the room that participate in the shared connections space 112 or the virtual meeting 122 can control the display device to show the collaborative visual space 114, a slide presentation, or watch slide presentations of other participants. Sound and/or camera control can similarly be performed.

As described previously, an audiovisual component of each client device 102A-N can capture images and generate video data (e.g., a video stream) of the captured data of the captured images. In some implementations, the client devices 102A-N transmit the generated video stream to the virtual meeting manager 142. The audiovisual component of each client device 102A-N can also capture an audio signal representing speech of a user and generate audio data (e.g., an audio file or audio stream) based on the captured audio signal. In some implementations, the client devices 102A-N transmit the generated audio data to the shared connections space manager 132 or the virtual meeting manager 142.

In some implementations, each client device 102A-N includes a respective shared connections space application 104A-N, which can be a mobile application, a desktop application, a web browser, etc. The shared connections space application 104A-N can present, on a display device of a client device 102A-N, a shared connections space UI, which may include one or more features of the shared connections space application 104A-N for users to access the shared connections space platform 110.

In one or more implementations, each client device 102A-N includes a virtual meeting application 106A-N, which can be a mobile application, a desktop application, a web browser, etc. The virtual meeting application 106A-N can present, on a display device of a client device 102A-N, a virtual meeting UI 107A-N, as discussed above. The users of the virtual meeting applications 106A-N can use the virtual meeting UIs 107A-N to access one or more features of the virtual meeting platform 120. In some implementations, the shared connections space application 104A-N and the virtual meeting application 106A-N may be a single application on the client device 102A-N.

In one or more implementations, at least a portion of the shared connections space manager 132 and/or at least a portion of the virtual meeting manager 142 are part of a client device 102A-N. For example, the shared connections space application 104A-N can include a portion of the shared connections space manager 132 and/or the virtual meeting application 106A-N an include a portion of the virtual meeting manager 142, which can respectively perform functionality related to the shared connections space 112 or the virtual meeting 122.

In some implementations, the data store 150 is a persistent storage that is capable of storing data as well as data structures to tag, organize, and index the data. A data item can include audio data and/or video stream data, in accordance with implementations described herein. The data store 150 can be hosted by one or more storage devices, such as main memory, magnetic or optical storage-based disks, tapes, hard drives, flash memory, and so forth. In some implementations, the data store 150 is a network-attached file server, while in other implementations, the data store 150 is some other type of persistent storage such as an object-oriented database, a relational database, and so forth, that can be hosted by the shared connections space platform 110, the virtual meeting platform 120, or one or more different machines (e.g., the shared connections space server 130 or the virtual meeting server 140) coupled to the shared connections space platform 110 or the virtual meeting platform 120 using the network 160. In some implementations, the data store 150 stores portions of audio and video streams received from one or more client devices 102A-N for the shared connections space platform 110 or the virtual meeting platform 120. Moreover, the data store 150 can store various types of media items, such as images, audio, videos, text data, links to web resources, or documents (e.g., a slide presentation, a text document, a spreadsheet, or any suitable electronic document (e.g., an electronic document including text, tables, videos, images, graphs, slides, charts, software programming code, designs, lists, plans, blueprints, maps, etc.)).

In some implementations, the network 160 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some implementations, the functions of the shared connections space platform 110, the virtual meeting platform 120, the shared connections space server 130, or the virtual meeting server 140 are provided by a fewer number of machines. For example, in some implementations, each of the shared connections space server 130 and the virtual meeting server 140 are respectively integrated into a single machine, while in other implementations, each server 130, 140 is integrated into multiple machines. In addition, in one or more implementations, the shared connections space platform 110 is integrated into the shared connections space server 130. Similarly, the virtual meeting platform 120 may be integrated into the virtual meeting server 140.

In general, one or more functions described in the several implementations as being performed by the shared connections space platform 110, the virtual meeting platform 120, the shared connections space server 130, or the virtual meeting server 140 can also be performed by the client devices 102A-N in other implementations, if appropriate. In addition, in some implementations, the functionality attributed to a particular component can be performed by different or multiple components operating together. The shared connections space platform 110, the virtual meeting platform 120, the shared connections space server 130, or the virtual meeting server 140 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

FIG. 2 illustrates an example AI training subsystem 200, in accordance with implementations of the present disclosure. As illustrated in FIG. 2, the AI training subsystem 200 may include a training subsystem 210, which may include a training data engine 212, a training engine 214, a validation engine 216, a selection engine 218, or a testing engine 220. The AI training subsystem 200 may include an AI model subsystem 230. The AI model subsystem 230 may include one or more AI models 232A-M.

In one implementation, the AI model 232A-M includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, an AI model 232A-M includes a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), or a large language model (LLM). In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some implementations, an AI model 232A-M is an AI model that has been trained on a corpus of data. In some implementations, the AI model 232A-M can be a model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 232A-M to learn broad elements including, image or speech recognition, general sentence structure, common phrases, vocabulary, natural language structure, and other elements. In some implementations, this first, foundational model is trained using self-supervision, or unsupervised training on such datasets. In some implementations, the AI model 232A-M is then further trained or fine-tuned on organizational data, including proprietary organizational data. The AI model 232A-M can also be further trained or fine-tuned on organizational data.

In some implementations, the second portion of training, including fine-tuning, may be unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 232A-M while training can be ranked by a user, according to a variety of factors, including accuracy, helpfulness, veracity, acceptability, or any other metric useful in the fine-tuning portion of training. In this manner, the AI model 232A-M can learn to favor these and any other factors relevant to users when generating a response. Further details regarding training are provided below.

In some implementations, an AI model 232A-M includes one or more pre-trained models, or fine-tuned models. In a non-limiting example, in some implementations, the goal of the “fine-tuning” is accomplished with a second, or third, or any number of additional models. For example, the outputs of the pre-trained model can be input into a second AI model 232A-M that has been trained in a similar manner as the “fine-tuned” portion of training above. In such a way, two more AI models 232A-M can accomplish work similar to one model that has been pre-trained, and then fine-tuned.

As indicated above, an AI model 232A-M may be one or more generative AI models 232A-M, allowing for the generation of new and original content. The generative AI model 232A-M can use other machine learning models including an encoder-decoder architecture including one or more self-attention mechanisms, and one or more feed-forward mechanisms. In some implementations, the generative AI model 232A-M includes an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model 232A-M can also utilize the previously discussed deep learning techniques, including RNNs, CNNs, or transformer networks. Further details regarding generative AI models 232A-M are provided herein.

In some implementations, different AI models 232A-M of the one or more AI models 232A-M are different types of AI models 232A-M. Multiple AI models 232A-M of the one or more AI models 232A-M can form an ensemble.

In one implementation, the training subsystem 210 manages the training and testing of the one or more AI models 232A-M. The training data engine 212 can generate training data (e.g., a set of training inputs and a set of target outputs) to train an AI model 232A-M. In an illustrative example, the training data engine 212 can initialize a training set T to null. The training data engine 212 can add the training data to the training set T and can determine whether training set T is sufficient for training the AI model 232A-M. The training set T can be sufficient for training the AI model 232A-M if the training set T includes a threshold amount of training data, in some implementations. In response to determining that the training set T is not sufficient for training, the training data engine 212 can identify additional data to use as training data. In response to determining that the training set T is sufficient for training, the training data engine 212 can provide the training set T to the training engine 214.

The training data may include data that indicate one or more participant actions during a virtual meeting 122. In one implementation, data that indicate one or more participant actions includes a portion of a transcript of a virtual meeting 122. A portion of a transcript may include one or more statements spoken by one or more participants of a virtual meeting 122. The virtual meeting 122 may include a virtual meeting 122 that occurred in the past. The one or more statements may include statements that were not actually made during an actual virtual meeting 122 but are similar to statements made during actual virtual meetings 122. In one implementation, data indicating one or more participant actions during a virtual meeting 122 includes data indicating an occurrence of a predetermined event during a virtual meeting 122. Data indicating the occurrence of a predetermined event may include data indicating that a participant of the virtual meeting 122 presented content in a region of the virtual meeting 122 (e.g., presented a slide presentation using a screen sharing feature of the virtual meeting 122). Data indicating the occurrence of a predetermined event may include data indicating that a participant provided a link to a document in a text chat feature of the virtual meeting 122. Data indicating the occurrence of a predetermined event may include data indicating that a participant activated a note-taking feature of the virtual meeting 122. For one or more pieces of training data, the training data may include a respective target output indicating whether the training input indicates that one or more participants of a virtual meeting 122 are interested in using a shared connections space 112.

The training engine 214 can train the AI model 232A-M using the training data (e.g., training set T). The AI model 232A-M can refer to the model artifact that is created by the training engine 214 using the training data, where such training data can include training inputs and, in some implementations, corresponding target outputs (e.g., correct answers for respective training inputs). The training engine 214 can input the training data into the AI model 232A-M so that the AI model 232A-M can find patterns in the training data and configure itself based on those patterns.

Where the AI model 232A-M uses supervised learning, the training engine 214 can assist the AI model 232A-M in determining whether the AI model 232A-M maps the training input to the target output (the answer to be predicted). Where the AI model 232A-M uses unsupervised learning, the training engine 214 can input the training data into the AI model 232A-M. The AI model 232A-M can configure itself based on the input training data, but since the training data may not include a target output, the training engine 214 may not assist the AI model 232A-M in determining whether the AI model 232A-M provided a correct output during the training process.

The validation engine 216 may be capable of validating a trained AI model 232A-M using a corresponding set of features of a validation set from the training data engine 212. The validation engine 216 can determine an accuracy of each of the trained AI models 232A-M based on the corresponding sets of features of the validation set. Where the training data may not include a target output, validating a trained AI model 232A-M may include obtaining an output from the AI model 232A-M and providing the output to another entity for evaluation. The other entity may include another AI model configured to evaluate the output of the AI model that is undergoing training. The other entity may include a human. The validation engine 216 can discard a trained AI model 232A-M that has an accuracy that does not meet a threshold accuracy or that otherwise fails evaluation. In some implementations, the selection engine 218 is capable of selecting a trained AI model 232A-M that has an accuracy that meets a threshold accuracy. In some implementations, the selection engine 218 is capable of selecting the trained AI model 232A-M that has the highest accuracy of multiple trained AI models 232A-M. In some implementations, the selection engine 218 obtains input from another AI model or a human and can select a trained AI model 232A-M based on the input.

The testing engine 220 may be capable of testing a trained AI model 232A-M using a corresponding set of features of a testing set from the training data engine 212. For example, a first trained AI model 232A-M that was trained using a first set of features of the training set may be tested using the first set of features of the testing set. The testing engine 220 can determine a trained AI model 232A-M that has the highest accuracy or other evaluation of all of the trained AI models 232A-M based on the testing sets.

As described above, the AI training subsystem 200 can be configured to train an LLM. It should be noted that the AI training subsystem 200 can train an LLM in accordance with implementations described herein or in accordance with other techniques for training LLMs. For example, an LLM may be trained on a large amount of data, including prediction of one or more missing words in a sentence, identification of whether two consecutive sentences are logically related to each other, generation of next texts based on prompts, etc.

In some implementations, the AI model subsystem 230 selects an AI model 232A-M from the one or more AI models 232A-M. Selecting an AI model 232A-M may include selecting the AI model 232A-M for training or for use. For example, the training subsystem 210 can provide data to the AI model subsystem 230 indicating which AI model 232A-M is to be trained. The AI model subsystem 230 can obtain data from a component of the shared connections space detection manager 148 indicating which AI model 232A-M to use to generate output.

FIG. 3 depicts one implementation of an AI inference subsystem 149. The AI inference subsystem 149 may include the AI model subsystem 230, which may include one or more AI models 232A-M. The AI inference subsystem 149 may include an AI input/output component 310. The AI input/output component 310 may be configured to feed data as input to an AI model 232A-M and obtain one or more outputs. In such implementations, the AI input/output component 310 feeds data indicating participant actions occurring during a virtual meeting 122 as input to an AI model 232A-M and obtains one or more outputs.

In some implementations, the AI inference subsystem 149 is not part of the shared connections space detection manager 148 and may, instead, be part of another system or subsystem or be an independent system. In some implementations, the AI inference subsystem 149 includes the AI training subsystem 200.

As indicated above, in some implementations, the AI model 232A-M includes an LLM. In some implementations, the LLM includes generative AI functionality. In such implementations, the AI model 232A-M generates new content based on provided input data (e.g., data indicating one or more participant actions during a virtual meeting 122). The generative AI model 232A-M can be supported by a prompt subsystem (not shown), which may reside on the virtual meeting server 140. The prompt subsystem can enable the shared connections space detection manager 148 to access the generative AI model 232A-M. The prompt subsystem may be configured to perform automated identification of, and facilitate retrieval of, relevant and timely contextual information for efficient and accurate processing of prompts by the AI model 232A-M. Using the network 160 (or another network), the prompt subsystem may be in communication with the data store 150. Communications between the prompt subsystem and the AI input/output component 310 may be facilitated by a generative model application programming interface (API), in some implementations. Communications between the prompt subsystem and the data store 150 may be facilitated by a data management API. In additional or alternative implementations, the generative model API translates prompts generated by the prompt subsystem into unstructured natural-language format and, conversely, translate responses received from the AI model 232A-M into any suitable form (e.g., including any structured proprietary format as may be used by the prompt subsystem).

In some implementations, the prompt subsystem includes a prompt analyzer to support various operations of this disclosure. For example, the prompt analyzer can receive an input (e.g., a prompt submitted by the shared connections space detection manager 148) and generate one or more intermediate prompts to the generative AI model 232A-M to determine what type of data the generative AI model 232A-M may need to successfully respond to the input. Upon receiving a response from the generative AI model 232A-M, the prompt analyzer can analyze the response, form a request for relevant contextual data for the data store 150 or some other component of the system 100, which can then supply such data. The prompt analyzer can then generate a prompt to the generative AI model 232A-M that includes the original prompt and the contextual data. In some implementations, the prompt analyzer, itself, includes a lightweight generative AI model that can process the intermediate prompt(s) and determine what type of contextual data may be needed by the generative AI model 232A-M together with the original prompt to ensure a meaningful response from generative AI model 232A-M.

The prompt subsystem may include (or may have access to) instructions stored on one or more tangible, machine-readable storage media of a computing device (e.g., the virtual meeting server 140) and executable by one or more processing devices of the computing device. In one implementation, the prompt subsystem is implemented on a single machine. In some implementations, the prompt subsystem is a combination of a client component and a server component.

FIG. 4 is a flowchart illustrating one embodiment of a method 400 for digital shared connections spaces, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 400 and/or one or more of the method's 400 individual functions, routines, subroutines, or operations. In certain implementations, a single processing thread can perform the method 400. Alternatively, two or more processing threads can perform the method 400, each thread executing one or more individual functions, routines, subroutines, or operations of the method. In an illustrative example, the processing threads implementing the method 400 can be synchronized (e.g., using semaphores, critical sections, and/or other thread synchronization mechanisms). Alternatively, the processing threads implementing the method 400 can be executed asynchronously with respect to each other. Various operations of the method 400 can be performed in a different (e.g., reversed) order compared with the order shown in FIG. 4. Some operations of the method 400 can be performed concurrently with other operations. Some operations can be optional. In some implementations, the shared connections space detection manager 148 performs one or more of the operations of the method 400.

At block 410, processing logic causes a virtual meeting user interface UI 107A-N to be presented during a virtual meeting between one or more participants. The virtual meeting UI 107A-N may include one or more first regions. Each first region may correspond to a participant of the one or more participants of the virtual meeting 122. As discussed above, each first region can display a visual item representing a video stream pertaining to one or more participants of the virtual meeting 122.

At block 420, processing logic determines that at least one participant of the one or more participants is interested in using a shared connections space 112. The shared connections space 112 may be configured to present one or more images of one or more media items referenced during the virtual meeting 122. In some implementations, determining that at least one participant is interested in using the shared connections space includes using an AI model 232A-M and one or more participant actions during the virtual meeting 122 as input to the AI model 232A-M.

In some implementations, responsive to an event occurring during the virtual meeting 122, the virtual meeting 122 may send data indicating the event to the virtual meeting manager 142. Events occurring during a virtual meeting 122 may include initializing the virtual meeting 122, concluding the virtual meeting 122, a participant joining the virtual meeting 122, or a participant exiting the virtual meeting 122. Events occurring during the virtual meeting 122 may include a participant using a second region of the virtual meeting UI 107A-N to present content, a participant sending a message through a text chat feature of the virtual meeting 122, a participant activating a certain feature of the virtual meeting 122 (e.g., a note-taking feature, a recording feature, or some other virtual meeting feature). The data indicating the event may include data identifying the type of the event (e.g., a participant joining the meeting, etc.). The data indicating the event may include data indicating a time and date the event occurred, a participant that initiated the event (if applicable), or other data associated with the event. The virtual meeting manager 142 may provide at least some of the event data to the shared connections space detection manager 148 to use to determine whether a participant of the virtual meeting 122 is interested in using a shared connections space 112.

In one implementation, the one or more participant actions include a presentation of content in a second region of the virtual meeting UI 107A-N by a first participant of the one or more participants of the virtual meeting 122. The second region of the virtual meeting UI 107A-N may include a region configured to display content in use by the first participant (e.g., via a screen sharing feature of the virtual meeting 122). The content may include a slide presentation, a text document, a spreadsheet, or any suitable electronic document (e.g., an electronic document including text, tables, videos, images, graphs, slides, charts, software programming code, designs, lists, plans, blueprints, maps, etc.). The content may include a file stored on the client device 102A of the first participant or may include a file stored on a cloud storage platform that is accessible to the first participant. In one implementation, the event data generated in response to the presentation of the content may include the content (e.g., a copy of the file or a link to the file).

In one implementation, the one or more participant actions include a first participant of the one or more participants using the virtual meeting UI 107A to share content with a second participant. Using the virtual meeting UI 107A-N to share content may include using a text chat feature of the virtual meeting 122 to share the content. Using the text chat feature may include the first participant inputting a link to the content into a text-based message and submitting the message to the virtual meeting 122. Using the text chat feature may include including a file in the text-based message (e.g., as an attachment). Using the virtual meeting UI 107A-N to share content may include other operations or functionality that participants of the virtual meeting 122 can use to exchange files, data, or other content between participants of the virtual meeting 122. In one implementation, the event data generated in response to the first participant using the virtual meeting UI 107A to share the content may include the content.

In one or more implementations, the one or more participant actions include a first participant of the one or more participants activating a note-taking feature of the virtual meeting 122. A virtual meeting 122 may include a note-taking feature, which may include the virtual meeting manager 142 obtaining audio data that includes the discussion between the participants of the virtual meeting 122, providing the audio data to a speech-to-text model to generate a text version of the discussion as a transcript of the virtual meeting 122, and providing the transcript to an AI model 232A-M that uses the transcript as input and generates one or more notes based on the transcript. In one implementation, the virtual meeting 122 may generate event data indicating the activation of the note-taking feature.

In one implementation, using the AI model 232A-M to determine that at least one participant is interested in using the shared connections space 112 includes using event data generated during the virtual meeting 122 as input to the AI model 232A-M. As discussed above the AI model 232A-M may include an AI model trained on data that indicate participant actions during a virtual meeting 122 (e.g., event data). The AI model 232A-M may generate an output based on the input event data. The output may indicate whether a participant of the virtual meeting 122 is interested in using a shared connections space 112.

As discussed above, in some implementations, the virtual meeting platform 120, the virtual meeting manager 142, a component of the virtual meeting manager 142, or a component of the virtual meeting server 140 may generate a transcript of the virtual meeting 122. Generating the transcript may include using a speech-to-text model that accepts audio of the virtual meeting 122 as input and generates a text version of the audio data as a transcript of the virtual meeting 122. The virtual meeting manager 142 may provide the transcript to the shared connections space detection manager 148, which may provide the transcript as input to the AI inference subsystem 149. Providing the transcript to the virtual meeting manager 142, shared connections space detection manager 148, or the AI inference subsystem 149 may include providing portions of the transcript (as opposed to the entire transcript all at once).

In some implementations, the one or more participant actions include a discussion between the one or more participants. The discussion may include the participants conversing about using a shared connections space 112. Determining, using the AI model 232A-M, that at least one participant is interested in using the shared connections space 112 may include using the AI model 232A-M and using a transcript of the virtual meeting 122 as the input to the AI model 232A-M to determine that at least one participant is interested in using the shared connections space 112.

In one or more implementations, using the AI model 232A-M to determine that at least one participant is interested in using the shared connections space 112 includes using a generative AI prompt as the input to the AI model 232A-M. The generative AI prompt may include at least a portion of the transcript. The generative AI prompt may include a command for the AI model 232A-M to determine whether the at least a portion of the transcript indicates that at least one participant is interested in using the shared connections space 112. The shared connections space detection manager 148 may input the portion of the transcript and the command into the prompt system discussed above, and the prompt subsystem may generate the generative AI prompt and provide the prompt to the AI model 232A-M. The AI model 232A-M may generate an output indicating whether the portion of the transcript indicates that a participant is interested in using the shared connections space 112. The AI inference subsystem 149 may provide the output to the shared connections space detection manager 148.

At block 430, processing logic instructs a shared connections space platform 110 to generate the shared connections space 112. One or more images of one or more media items referenced during the virtual meeting 122 may be viewable on a shared connections space UI after the virtual meeting 122 is concluded.

As discussed above, a shared connections space 112 may include a collaborative visual space 114 that includes one or more images of one or more media items. The collaborative visual space 114 may act as a digital bulletin board where participants of the shared connections space 112 can add media items (represented by images) to the collaborative visual space 114 so other participants of the shared connections space 112 can interact with the media items.

In some implementations, responsive to the shared connections space detection manager 148 determining that a participant of the virtual meeting 122 is interested in using a shared connections space 112, the shared connections space detection manager 148 instructs the shared connections space platform 110 to generate the shared connections space 112. Instructing the shared connections space platform 110 to generate the shared connections space 112 may include the virtual meeting manager 142 providing data to the shared connections space platform 110 used to generate the shared connections space 112 or data used to include media items in the shared connections space 112. The data may include a name of the shared connections space 112, identities of one or more participants for the shared connections space 112, an identity of a host participant for the shared connections space 112, or other information. In some implementations, responsive to the shared connections space detection manager 148 notifying the shared connections space platform 110 that a participant of the virtual meeting 122 is interested in using a shared connections space 112, the shared connections space platform 110 can determine that the shared connections space 112 of interest already exists and can cause the participant to be connected to the shared connections space 112. The shared connections space manager 148 can detect that the shared connections space 112 of interest already exists based on the above data, including a name of the shared connections space 112, identities of one or more participants of the shared connections space 112, an identity of a host participant for the shared connections space 112, or other data.

In one implementation, a media item includes image data. Image data may include an image file or another data format that is renderable as an image on a UI. A media item may include video data. Video data may include a video file, a video stream, or another data format that is renderable as video on a UI. A media item may include audio data. Audio data may include an audio file, an audio stream, or another data format that is playable as audio in a UI.

In some implementations, a media item includes text data. Text data may include one or more text characters, data indicating how the text characters are to be displayed (e.g., a font, a color, a size, kerning data, spacing data, text effects data (e.g., bold, italics, underline, etc.)), or other data associated with displaying text. A media item may include a document. The document may include a document stored on a cloud storage platform. The document may include a slide presentation, a text document, a spreadsheet, or any suitable electronic document (e.g., an electronic document including text, tables, videos, images, graphs, slides, charts, software programming code, designs, lists, plans, blueprints, maps, etc.). A media item may include a link to a web resource stored on a server. The web resource may include a web page, an application (e.g., a web mapping application, an email application, a virtual meeting application, a cloud storage application, or other online applications), a database, or another type of web resource. A web resource may be identified by a Uniform Resource Identifier (URI), an Internet Protocol (IP) address, or another type of identifier.

In some implementations, the virtual meeting manager 142 may provide content to the shared connections space 112 to be added to the shared connections space as a media item. The content may include content presented in a second region of the virtual meeting UI 107A-N or content shared between participants of the virtual meeting 122. The virtual meeting manager 142 may obtain the content from event data generated during the virtual meeting 122. Providing the content to the shared connections space 112 may include the virtual meeting manager 142 providing the content to the collaborative visual space manager 134, which may use the content to generate a media item corresponding to the content and add the media item to the collaborative visual space 114 of the shared connections space 112.

In one implementation, the shared connections space detection manager 148 may use an AI model 232A-M (which may be different from the AI model 232A-M discussed above regarding block 420) to generate a media item to add to the shared connections space 112. The shared connections space detection manager 148 may use event data generated during the virtual meeting 122 as input to the AI model 232A-M. The shared connections space detection manager 148 may use a transcript of the virtual meeting 122 as input to the AI model 232A-M. The AI model 232A-M may generate a media item based on the input. Generating the media item may include selecting a media item from a web resource (e.g., an image from a website that is relevant to the input to the AI model 232A-M), the data store 150, a cloud storage platform, or some other location. By using an AI model 232A-M to generate media items to add to the shared connections space 112, the shared connections space detection manager 148 can add relevant media items to the shared connections space 112 even if the participants of the virtual meeting 122 did not explicitly share or discuss those media items.

In some implementations, the shared connections space platform 110 generates the shared connections space 112 during the virtual meeting 122. One or more participants of the virtual meeting 122 may access the shared connections space 112 during the virtual meeting 122.

In one or more implementations, the virtual meeting manager 142 may cause the virtual meeting UI 107A-N to present a UI element that a participant of the virtual meeting 122 can interact with to access the shared connections space 112. The UI element may include a URI or other identifier that can identify the shared connections space 112 or link to the shared connections space 112. The virtual meeting manager 142 may obtain the URI from the shared connections space platform 110 or the shared connections space manager 132 responsive to the shared connections space platform 110 generating the shared connections space 112. The virtual meeting manager 142 may provide the URI to the shared connections space 112 in an email, text message, or push notification to a participant of the virtual meeting 122.

In some implementations, the shared connections space 112 persists even after the virtual meeting 122 is concluded. The virtual meeting 122 may conclude responsive to the participants of the virtual meeting 122 disconnecting from the virtual meeting 122, a time limit associated with the virtual meeting expiring, or the like. The shared connections space 112 persisting may include the shared connections space 112 being accessible by a shared connections space application 104A-N, the collaborative visual space 114 being accessible, or the like.

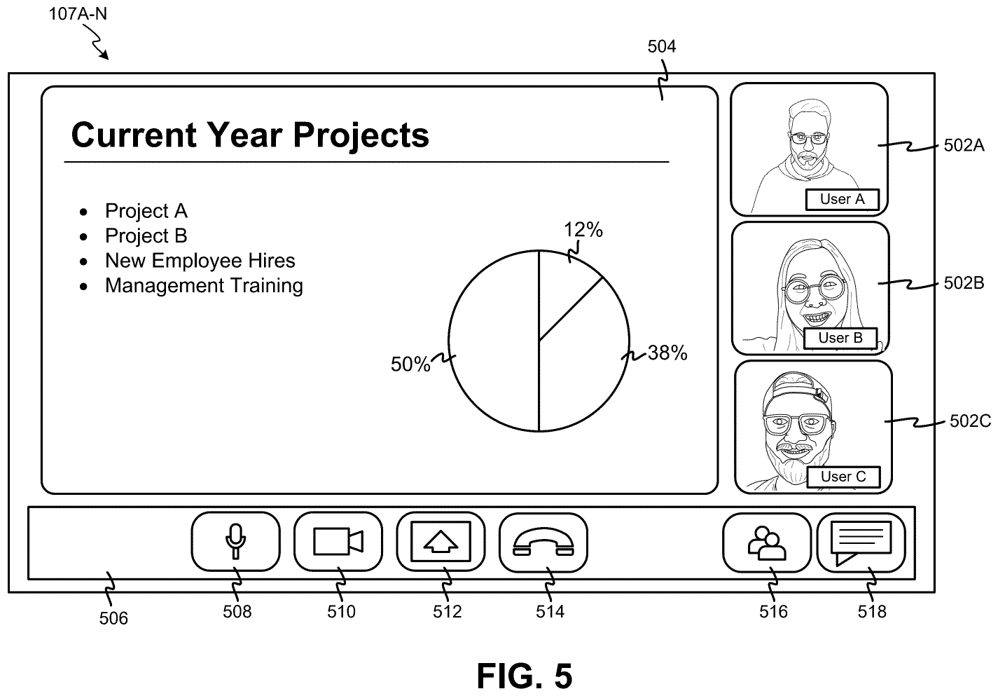

FIG. 5 depicts a virtual meeting UI 107A-N for a virtual meeting 122, in accordance with some implementations of the present disclosure. The virtual meeting UI 107A-N may include one or more first regions 502A-C corresponding to a visual item of the virtual meeting 122, where the visual item represents a video stream provided by a client device 102A-N of a participant of the virtual meeting 122. The virtual meeting UI 107A-N can include a second region 504. As discussed above, a first participant of the virtual meeting 122 may present content in the second region 504 (e.g., as shown in FIG. 5, a slide presentation).

The virtual meeting UI 107A-N may include a toolbar 506 that includes one or more UI elements configured to perform virtual meeting operations. For example, as seen in FIG. 5, the toolbar 506 includes an audio control button 508 used to mute and unmute a participant's audio stream, a camera control button 510 used to mute and unmute a participant's video stream, a screen share button 512 used to share a participant's client device's 102A-N screen with other participants of the virtual meeting 122, and a disconnect button 514 used to leave or disconnect from the virtual meeting 122. The toolbar 506 may include a participants button 516 that can display a list of the one or more participants of the virtual meeting 122. The toolbar 506 may include a chat button 518 that can display a chat interface that allows participants of the virtual meeting 122 to send and receive chat messages in the virtual meeting 122.

As discussed above, in some implementations, responsive to the first participant presenting content in the second region 504, the virtual meeting platform 120 or virtual meeting application 105 can generate event data indicating that the first participant presented the content, and the shared connections space detection manager 148 may use the event data to determine whether the first participant is interested in using a shared connections space 112.

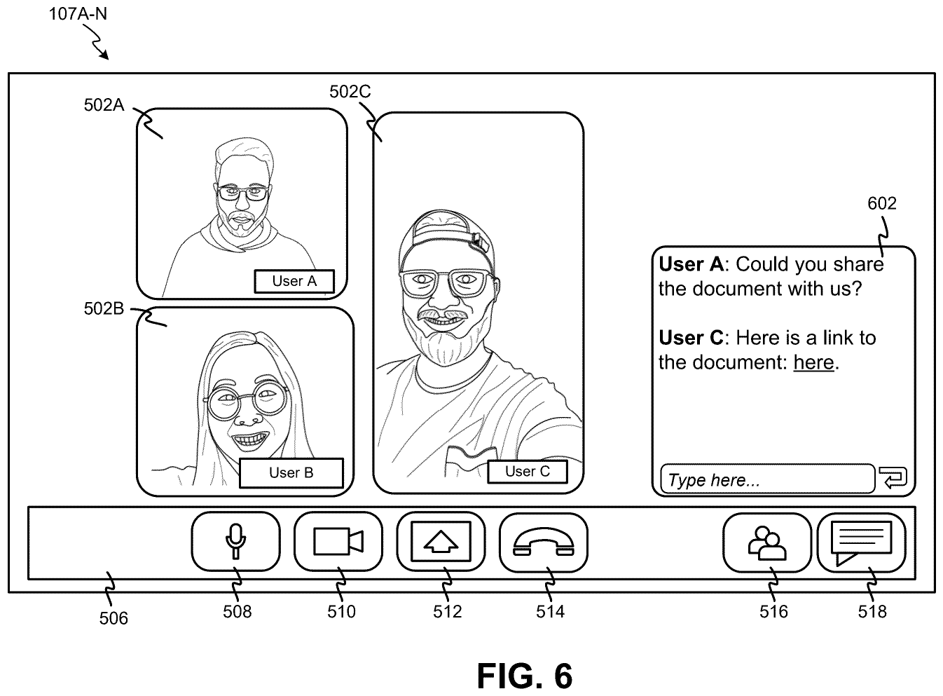

FIG. 6 depicts another virtual meeting UI 107A-N, in accordance with some implementations of the present disclosure. The virtual meeting UI 107A-N of FIG. 6 may include one or more components of the virtual meeting UI 107A-N of FIG. 5. In one implementation, the virtual meeting UI 107A-N includes a text chat UI element 602. The virtual meeting UI 107A-N may present the text chat UI element 602 responsive to the participant of the client device 102A-N displaying the UI 107A-N interacting with the chat button 518.

The text chat UI element 602 can display one or more text-based messages sent by participants during the virtual meeting 122. The text chat UI element 602 may include an input UI element where a participant can enter text data to be sent to the virtual meeting manager 142. The virtual meeting manager 142 may send the text data to the virtual meeting applications 107A-N of other participants of the virtual meeting 122 for presentation in the respective text chat UI elements 602 of the other participants.

As can be seen in FIG. 6, a first participant may share content with other participants of the virtual meeting 122 by including the content (which may include a link to the content) text data sent using the text chat UI element 602. As discussed above, in some implementations, responsive to the first participant sharing content (e.g., using the text chat UI element 602), the virtual meeting platform 120 or virtual meeting application 105 can generate event data indicating that the first participant shared the content, and the shared connections space detection manager 148 can use the event data to determine whether the first participant is interested in using a shared connections space 112. In some implementations, if the shared connections space detection manager 148 determines that the first participant is interested in using a shared connections space 112, the shared connections space detection manager 148 can cause the shared connections space platform 110 to provide the first participant with access to the shared connections space 112 (e.g., a newly created or existing shared connections space). In some implementations, prior to providing the first participant with access to the shared connections space 112, the shared connections space detection manager 148 allows the first participant to confirm their interest in using a shared connections space 112 (e.g., by presenting, in the UI 107A-N, a message (not shown) and a UI element (not shown) to confirm interest).

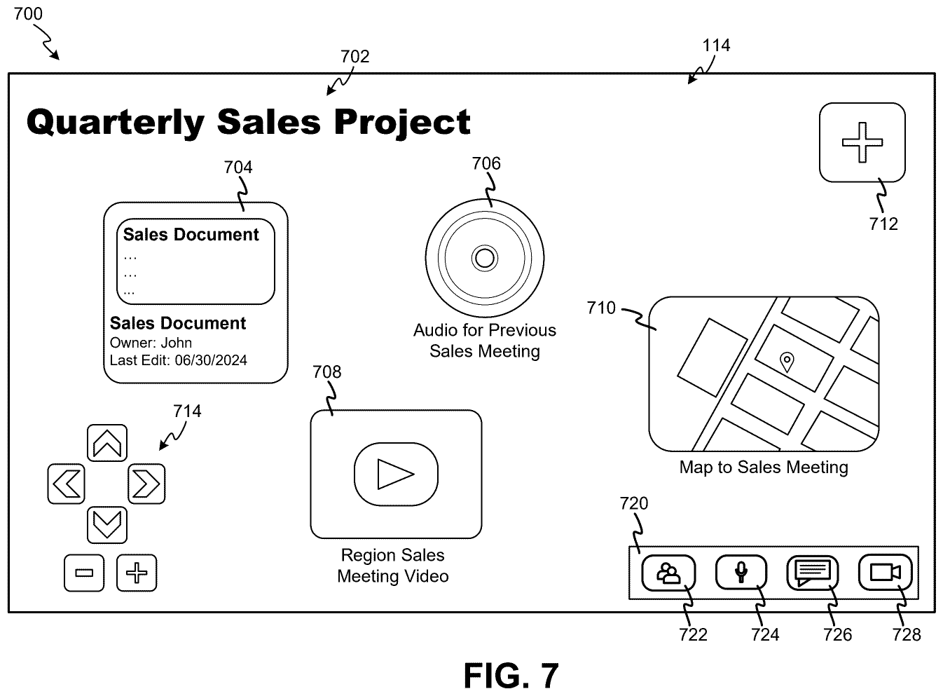

FIG. 7 depicts a shared connections space UI 700 displaying a collaborative visual space 114 of a shared connections space 112, in accordance with some implementations of the present disclosure. The UI 700 may be presented on a display device of a client device 102A-N. In one implementation, the UI 700 may include the collaborative visual space 114. The collaborative visual space 114 may include a title 702. The title 702 may include text, images, or other data that a participant can view to identify the shared connections space 112.

The collaborative visual space 114 may include one or more images of media items 704-710. For example, the collaborative visual space 114 may include an image 704 of a document. The collaborative visual space 114 may include an image 706 of audio data. The collaborative visual space 114 may include an image 708 of video data. The collaborative visual space 114 may include an image 710 of a web resource. A participant can interact with the images 704-710 to cause the media items to perform actions.

The UI 700 may include a UI element 712 for adding a media item to the collaborative visual space 114. In one implementation, responsive to a participant interacting with the UI element 712, the UI 700 presents a UI element (e.g., a file selector) where the participant can provide a media item for adding to the collaborative visual space 114.

The UI 700 may include a navigation UI element 714. The navigation UI element 714 may include UI elements (e.g., buttons) that a participant can interact with to navigate about the collaborative visual space 114. For example, the navigation UI element 714 may include one or more arrow buttons that cause the collaborative visual space 114 to scroll in a certain direction. The navigation UI element 714 may include a zoom-in button or a zoom-out button that cause the UI 105A-N to zoom in or out of the collaborative visual space 114.

In some implementations, the UI 700 includes a toolbar 720. The toolbar 720 may include one or more UI elements 722-728 (e.g., buttons) that can present one or more features of the shared connections space application 104A-N. The toolbar 720 may include a participant list UI element 722 that can cause the UI 700 to present a list of participants of the shared connections space 112 that are currently accessing the shared connections space 112. The toolbar 720 may include an audio chat UI element 724 (e.g., a push-to-talk button) that can cause the shared connections space application 104A-N to obtain audio data from a microphone of the client device 102A-N and provide the audio data to the shared connections space manager 132 so the shared connections space manager 132 can provide the audio data to the shared connections space applications 104A-N of participants currently accessing the shared connections space 112 for playback to other participants. The toolbar 720 may include a text chat UI element 726 that can cause the UI 700 to display a text chat interface where the participants can input text to be sent to other participants and where the participants can view text sent by other participants. The toolbar 720 may include a virtual meeting launch UI element 728 that can cause the initialization of a virtual meeting 122 (which may be different than the virtual meeting 122 discussed above regarding the method 400).

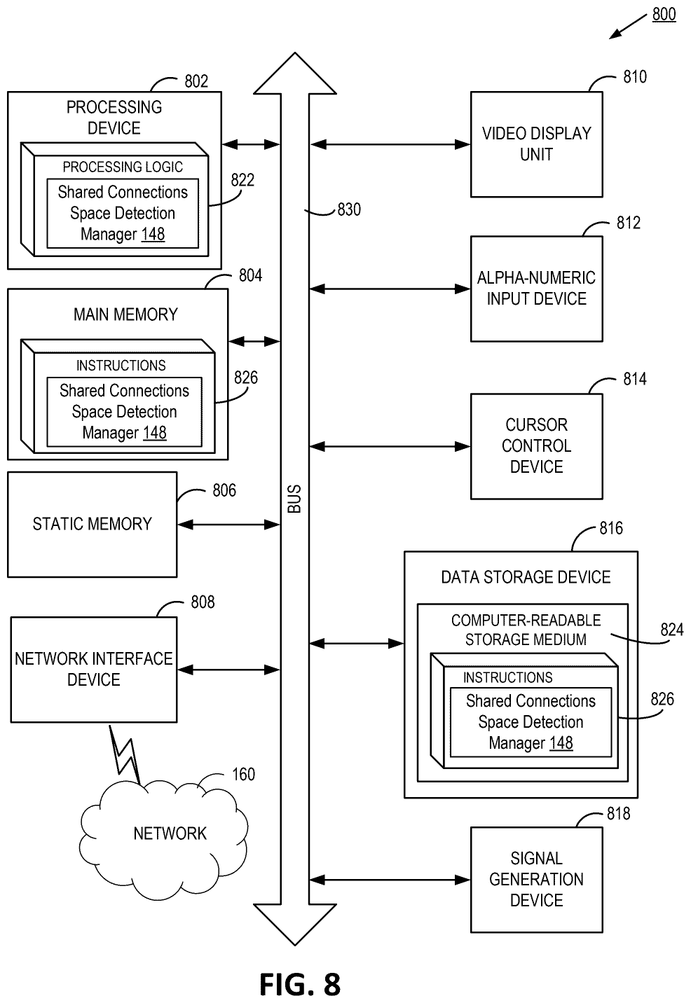

FIG. 8 is a block diagram illustrating an example computer system, in accordance with implementations of the present disclosure. The computer system 800 can include a client device 102A-N, the shared connections space platform 110, the virtual meeting platform 120, the shared connections space server 130, or the virtual meeting server 140 of FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a main memory 804 (e.g., read-only memory (ROM), flash memory, dynamic random access memory (DRAM) such as synchronous DRAM (SDRAM), double data rate (DDR SDRAM), or DRAM (RDRAM), etc.), a static memory 806 (e.g., flash memory, static random access memory (SRAM), etc.), and a data storage device 816, which communicate with each other via a bus 830.

The processing device 802 represents one or more general-purpose processing devices such as a microprocessor, central processing unit, or the like. More particularly, the processing device 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. The processing device 802 is configured to execute the processing logic 822 for performing the operations discussed herein (e.g., the operations of the shared connections space detection manager 148).

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a non-transitory machine-readable storage medium 824 (sometimes referred to as a “computer-readable storage medium”) on which is stored one or more sets of instructions 826 (e.g., the instructions to carry out one or more operations of the shared connections space detection manager 148) embodying any one or more of the methodologies or functions described herein. The instructions can also reside, completely or at least partially, within the main memory 804 and/or within the processing device 802 during execution thereof by the computer system 800, the main memory 804 and the processing device 802 also constituting machine-readable storage media. The instructions can further be transmitted or received over the network 160 via the network interface device 808.

In one implementation, the instructions 826 include instructions for determining visual items for presentation in a user interface of a virtual meeting. While the computer-readable storage medium 824 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method, comprising:
causing a virtual meeting user interface (UI) to be presented during a virtual meeting between a plurality of participants, the virtual meeting UI comprising a plurality of first regions each corresponding to a participant of the plurality of participants;
determining, using an artificial intelligence (AI) model and one or more participant actions during the virtual meeting as input to the AI model, that at least one participant of the plurality of participants is interested in using a shared connections space that is configured to present one or more images of one or more media items referenced during the virtual meeting; and
instructing a shared connections space platform to generate the shared connections space, wherein the one or more images of the one or more media items referenced during the virtual meeting are viewable on a shared connections space UI after the virtual meeting is concluded.

2. The method of claim 1, wherein the one or more participant actions comprises a presentation of content in a second region of the virtual meeting UI by first participant of the plurality of participants.

3. The method of claim 2, further comprising providing, to the shared connections space, the content presented in the second region of the virtual meeting UI.

4. The method of claim 1, wherein the one or more participant actions comprises a first participant of the plurality of participants using the virtual meeting UI to share content with a second participant of the plurality of participants.

5. The method of claim 1, wherein:
the one or more participant actions comprises a discussion between the plurality of participants to use the shared connections space; and
determining, using the AI model, that at least one participant of the plurality of participants is interested in using the shared connections space comprises using the AI model and using a transcript of the virtual meeting as the input to the AI model to determine that at least one participant of the plurality of participants is interested in using the shared connections space.

6. The method of claim 5, wherein:
using the AI model to determine that at least one participant of the plurality of participants is interested in using the shared connections space comprises using a generative AI prompt as the input to the AI model; and
the generative AI prompt comprises:
at least a portion of the transcript, and
a command for the AI model to determine whether the at least a portion of the transcript indicates that at least one participant of the plurality of participants is interested in using the shared connections space.

7. The method of claim 1, wherein the one or more participant actions comprises a first participant of the plurality of participants activating a note-taking feature of the virtual meeting.

8. A system, comprising:
a memory; and
a processing device, coupled to the memory, configured to perform operations comprising:
causing a virtual meeting user interface (UI) to be presented during a virtual meeting between a plurality of participants, the virtual meeting UI comprising a plurality of first regions each corresponding to a participant of the plurality of participants;
determining, using an artificial intelligence (AI) model and one or more participant actions during the virtual meeting as input to the AI model, that at least one participant of the plurality of participants is interested in using a shared connections space that is configured to present one or more images of one or more media items referenced during the virtual meeting; and
instructing a shared connections space platform to generate the shared connections space, wherein the one or more images of the one or more media items referenced during the virtual meeting are viewable on a shared connections space UI after the virtual meeting is concluded.

9. The system of claim 8, wherein the operations further comprise:
using the AI model to generate a first media item to add to the shared connections space; and
providing the first media item to the shared connections space.

10. The system of claim 9, wherein the first media item comprises at least one of:
image data;
video data; or
audio data.

11. The system of claim 9, wherein the first media item comprises at least one of:
text data;
a document stored on a cloud storage platform; or
a link to a web resource stored on a server.

12. The system of claim 8, wherein the one or more participant actions comprises presentation of content in a second region of the virtual meeting UI by first participant of the plurality of participants.

13. The system of claim 8, wherein the one or more participant actions comprises a first participant of the plurality of participants using the virtual meeting UI to share content with a second participant of the plurality of participants.

14. The system of claim 8, wherein:
the one or more participant actions comprises a discussion between the plurality of participants to use the shared connections space; and
determining, using the AI model, that at least one participant of the plurality of participants is interested in using the shared connections space comprises using the AI model and using a transcript of the virtual meeting as the input to the AI model to determine that at least one participant of the plurality of participants is interested in using the shared connections space.

15. The system of claim 14, wherein:
using the AI model to determine that at least one participant of the plurality of participants is interested in using the shared connections space comprises using a generative AI prompt as input to the AI model; and
the generative AI prompt comprises:
at least a portion of the transcript, and
a command for the AI model to determine whether the at least a portion of the transcript indicates that at least one participant of the plurality of participants is interested in using the shared connections space.

16. A non-transitory computer-readable storage medium with instructions that, when executed by a processing device, cause the processing device to perform operations comprising:
causing a virtual meeting user interface (UI) to be presented during a virtual meeting between a plurality of participants, the virtual meeting UI comprising a plurality of first regions each corresponding to a participant of the plurality of participants;
determining, using an artificial intelligence (AI) model and one or more participant actions during the virtual meeting as input to the AI model, that at least one participant of the plurality of participants is interested in using a shared connections space that is configured to present one or more images of one or more media items referenced during the virtual meeting; and
instructing a shared connections space platform to generate the shared connections space, wherein the one or more images of the one or more media items referenced during the virtual meeting are viewable on a shared connections space UI after the virtual meeting is concluded.

17. The computer-readable storage medium of claim 16, wherein the one or more participant actions comprises a first participant of the plurality of participants using the virtual meeting UI to share content with a second participant of the plurality of participants.

18. The computer-readable storage medium of claim 16, wherein:
the one or more participant actions comprises a discussion between the plurality of participants to use the shared connections space; and
determining, using the AI model, that at least one participant of the plurality of participants is interested in using the shared connections space comprises using the AI model and using a transcript of the virtual meeting as the input to the AI model to determine that at least one participant of the plurality of participants is interested in using the shared connections space.

19. The computer-readable storage medium of claim 18, wherein:
using the AI model to determine that at least one participant of the plurality of participants is interested in using the shared connections space comprises using a generative AI prompt as input to the AI model; and
the generative AI prompt comprises:
at least a portion of the transcript, and
a command for the AI model to determine whether the at least a portion of the transcript indicates that at least one participant of the plurality of participants is interested in using the shared connections space.

20. The computer-readable storage medium of claim 16, wherein the one or more participant actions comprises a first participant of the plurality of participants activating a note-taking feature of the virtual meeting.
